(19) United States
(12) Patent Application Publication
(10) Pub. No.: US 2022/0164633 A1
(43) Pub. Date: May 26, 2022

(54) TIME-BASED ARTIFICIAL INTELLIGENCE ENSEMBLE SYSTEMS WITH DYNAMIC USER INTERFACING FOR DYNAMIC DECISION MAKING

(71) Applicants: Michael William Kotarinos, Palm Harbor, FL (US); Dustin Arthur Tracy, Palm Harbor, FL (US)

(72) Inventors: Michael William Kotarinos, Palm Harbor, FL (US); Dustin Arthur Tracy, Palm Harbor, FL (US)

(21) Appl. No.: 17/101,191

(22) Filed: Nov. 23, 2020

(51) Int. Cl. G06N 3/04; G06N 3/08

(52) U.S. Cl. CPC G06N 3/0454; G06N 3/0445; G06N 3/049; G06N 3/08; G06N 3/0472

(57) ABSTRACT

A business process is presented to analyze data using an ensemble of methods in a dynamic environment that adjusts and reconfigures the analytical methods and procedures based on the preferences of the user. Data is analyzed and cleaned to allow for analysis to allow for dynamic modeling and analysis using an ensemble, whereas an ensemble is a mix of multiple analytical procedures such as Long Short-Term Memory and regression in unison. This ensemble is dynamically optimized and adjusted using methods such as Markov Chain Monte Carlo to allow for efficient and scalable operations. These methods allow for dynamic systems that allow for modularity, such as the option to add stochastic memory to the system. Once the user is provided with an output from the system, the modularity of the system, combined with the efficient and scalable implementation, allows for the system to adjust itself based on inputs and the desire of the user. The system can thus adjust the underlying processes and procedures based on dynamic user interactions and reconfigure itself to allow for customization and unique instances at the individual user level.

### FIELD OF THE INVENTION

The present invention pertains generally to the structure of ensemble systems using artificial intelligence-based methods that allow for dynamic user interfacing and interaction for decision making. These methods include but are not limited to Markov Chain Monte Carlo, Long Short-Term Memory, regression, and other techniques both independently and in unison. Specifically, this present innovation allows for decision-making environments that are dynamic and adjust based on interactions from the user that allow for deployment of decision-making architecture in specialized instances customized to individual users and learns the user's preferences tendencies over time.

### BACKGROUND OF THE INVENTION

There has recently been a surge in interest in machine learning applications-based methods to prediction and forecasting. Machine learning methods are a broad class of artificial intelligence-based methods with different forms and structures based on their area of application. One particular area of application involves the use of machine learning methods on panel data. Panel data refers to data that is indexed and has structural relationships over time. In finance, since most of the data generated by exchanges is panel data, data science areas focused on panel data. Panel data such as time series analysis and time series econometrics are essential research areas. One of the most common machine learning techniques in this area is Long Short-Term Memory, commonly referred to as LSTM.

One of the earliest applications that drove interest in using time-based evaluation systems was Google's AlphaGo system. AlphaGo is a specialized system built to play Go, a complex board game exponentially more computationally challenging to analyze than Chess. While each game state is evaluated independently, the system could be considered time-based as it evaluates how a position will evolve and change over time as various moves are played.

While computer engines could completely dominate any Chess Grandmaster, specialists thought Go's complexity made it unplayable at a grandmaster level for computer engines. AlphaGo used a machine learning-based approach trained to analyze and detect patterns and form strategies over time, rather than use a traditional minimax algorithm to determine scores and moves. In March 2016, AlphaGo defeated the world's strongest Go player at the time, Lee Sedol, with a score of 4 to 1 (Wang, Fei-Yue, et al. “Where does AlphaGo go: From church-turing thesis to AlphaGo thesis and beyond.” IEEE/CAA Journal of Automatica Sinica 3.2 (2016): 113-120.)

AlphaGo's win over Sedol was a monumental advancement for the theory and application of time-based machine learning frameworks. This advancement addressed many of the long-term forecasting problems and computational issues in traditional frameworks and lead to many new research areas and applications. This advancement showed that methods such as LSTM could have applications in a wide variety of areas beyond those previously thought viable.

AlphaGo's win led to the creation of additional research projects such as AlphaZero, created by Google's Deepmind division to play Chess against other Chess engines. The AlphaZero extension modified and enhanced older evaluation algorithms within the AlphaGo system to allow for more nuanced evaluations. While the new program could play Go and other games, researchers had designed it for assessment against traditional chess engines (Xu, Lei. “Deep bidirectional intelligence: AlphaZero, deep IA-search, deep IA-infer, and TPC causal learning.” Applied Informatics. Vol. 5. No. 1. Springer Berlin Heidelberg, 2018). With only 4 hours of calibration and neural training, the AlphaZero was able to defeat the strongest competitor chess engine at the time, Stockfish 8, with a record of 28 wins, 72 draws, and no losses out of 100 games.

The success of AlphaGo led to additional research into artificial intelligence systems in other applications. Recently, researchers released an open-source engine of AlphaGo called Leela Chess Zero, capable of competing on equal footing with the newest version of Stockfish (Stockfish 12). Systems based on a similar architecture, called Open AI, achieved success at mainstream video games such as StarCraft 2, Pac-Man (Risi, Sebastian, and Mike Preuss. “From Chess and Atari to StarCraft and Beyond: How Game AI is Driving the World of AI.” KI-Künstliche Intelligenz 34.1 (2020): 7-17) and Dota 2 and suggested that AI-based systems using panel data are capable of learning complex and nuanced relationships over time with proper calibration and tuning (Berner, Christopher, et al. “Dota 2 with large scale deep reinforcement learning.” arXiv preprint arXiv:1912.06680 (2019).) The success of these programs renewed interest in corporate applications for prediction and analysis of panel-based AI systems.

One study using publicly available consumer-grade data on Chinese exchanges found that LSTM-based training models lead to significant improvements in return predictions of assets (Chen, Kai, Yi Zhou, and Fangyan Dai. “A LSTM-based method for stock returns prediction: A case study of China stock market.” 2015 IEEE international conference on big data (big data). IEEE, 2015). While this paper shows that such methods are viable, it is limited in its data usage and scope. Most financial firms use sophisticated data systems that contain proprietary data not available to the typical consumer and incorporate advanced hardware and systems. As such, the methods in the Chen paper should be considered a proof-of-concept rather than a complete system. With more sophisticated analytical systems, one must cope with data inconsistencies, time variations, and subtle effects that are not present in the Chen paper.

One particular innovation in the space of LSTM is the use of grid LSTM systems. Grid LSTM is a modification to the LSTM process that arranges data in multidimensional grids (Kalchbrenner, Nal, Ivo Danihelka, and Alex Graves. “Grid long short-term memory.” arXiv preprint arXiv:1507.01526 (2015). While such a method has promise in addressing higher-dimensional data, the paper in question only investigated in-depth 2 by 2 grids. As the size of the grid increases, the analysis quickly runs into dimensional and computational issues. As such, the grid LSTM method cannot, on its own, address dimensionality issues. This method is viable and promising in low-dimensional space. Still, even though it is a multidimensional extension as prior art, it is not at this time a comprehensive framework that can address high dimensional spaces without dimensional reduction techniques.

One issue when dealing with higher dimensionality is the variability that occurs across high-dimensional space. Latent variable models aim to address this by attempting to learn and mimic this variability over time (Chung, Junyoung, et al. “A recurrent latent variable model for sequential data.” Advances in neural information processing systems. 2015.) One issue with the techniques of the Chung paper on latent variable data is that the study addressed systems such as speech, where past tendencies in speech tend to be consistent and occur in speakers in the future. In other words, the variability may be complex but is structured and stationary over time. In financial data, variability is not structured or stationary. A non-stationary financial data process are processes over time where the mean and variance are not stable. For example, a company's daily return for a certain period of stability may be around 0% (flat), may be positive during an economic boom and may be negative during a recession. As such, the mean return will change over time, and would be considered non-stationary. Many financial processes exhibit this characteristic, and specialized analysis is often necessary for such patterns and trends.

For example, volatility during periods of uncertainty will often be very high, and as such, this kind of variability is not consistent and requires additional analysis to determine the nature of volatility over time. The latent variables models may be useful for understanding latency in systems with a well-behaved underlying structure, but as prior art have issues when extended into complex and nuanced financial systems. Similar problems are prevalent in image-generation neural network systems (Gregor, Karol, et al. “Draw: A recurrent neural network for image generation.” arXiv preprint arXiv:1502.04623 (2015)). While Gregor et al's work shows some promise in describing and mapping data trends over time, it is not appropriate to financial systems with advanced architecture where data does not behave neatly over time.

One of the more recent papers in the prior art focused on stock predictions using a mix of LSTM and random forests (Ma, Yilin, Ruizhu Han, and Xiaoling Fu. “Stock prediction based on random forest and LSTM neural network.” 2019 19th International Conference on Control, Automation and Systems (ICCAS). IEEE, 2019). However, the Ma et al paper is quite limited in its investigative scope. The algorithms are only used on results from a single index, and as such this as prior art only represents a proof of concept. This particular deployment was in an environment with limited amounts of data on a single index, rather than a full set of high-dimensional data. The methods introduced and proposed in the Ma paper do not exhibit scalability and consistency in higher dimensions and are not optimized to work in real-time in across large data sets.

One patent application discussing LSTM methods with a risk and data reduction focus is by U.S. Published Patent Application No. 2002/0314101 (Zhang et al.). Zhang teaches that the inventors can use an LSTM system to make determinations regarding whether an authorization request is valid or not. This system differs from the present innovation in several ways. First, Zhang et al. has a binary final response (whether an authorization is valid or not). The present invention on the other hand has numerous responses (e.g. not just 0 and 1 but many possible outputs) in high dimensions, and as such, the Zhang system could not address numerous responses. The present invention extends the theory and deployment to more complex computational systems. Furthermore, the detailed description included in this disclosure uses CPU systems and references several manufacturers of CPU-based systems. There is no reference in the prior disclosure of GPU-based systems. GPU-based systems are more efficient for many machine learning-based tasks, and modern computing architecture often uses GPU-based systems for scalable analysis (Mittal, Sparsh. “A Survey on optimized implementation of deep learning models on the NVIDIA Jetson platform.” Journal of Systems Architecture 97 (2019): 428-442). Studies have found that the CPU-based architecture proposed in this application are not competitive with modern GPU-based architecture on analysis at scale (El Zein, Ahmed, et al. “Performance evaluation of the nvidia geforce 8800 gtx gpu for machine learning.” International Conference on Computational Science. Springer, Berlin, Heidelberg, 2008.) This finding raises questions about the application of the Zhang et al disclosure at scale (Vasilache, Nicolas, et al. “Tensor comprehensions: Framework-agnostic high-performance machine learning abstractions.” arXiv preprint arXiv:1802.04730 (2018).)

U.S. Published Patent Application No. 2020/0314117 (Nguyen, et al.) focuses on the use of LSTM for monitoring system security violations and event reporting. Nguyen et al. focuses heavily on classifying and determining relationships among command-line event reports. Nguyen et al. differs in scope and application from the present invention. In particular, the Nguyen, et. al. system analyzes network traffic to establish relations using LSTM among malicious packets. Nguyen et al. focuses almost exclusively on characterizing and classifying network traffic rather than making predictive models about assets, portfolios, or high-dimensional spaces. In particular, these systems do not explicitly mention a single method but are broad-based techniques using clustering or dimensionality-reducing techniques or other techniques, rather than using multiple techniques in conjunction. In particular, the illustrative environment explicitly mentions using dimensionality reduction or clustering, not both these techniques together. This document seems to view that techniques and approaches are competing methods that represent different ways of performing a task, rather than tools that can be combined. Because of this, the techniques of Nguyen et al. are different in scope and procedure than the present invention.

U.S. Published Patent Application No. 2020/0313434 (Khanna et al.) addresses the use of LSTM for predictive power modeling. While this patent does make predictive results using LSTM, it is limited in scope to power usage. As such, this limitation restricts its investigation to data with a more simplified structure, as it focuses on predicting how much power will be consumed at a given time. The proposed system uses past power consumption data, while the present invention in this application uses an ensemble of systems that operate on varied and diverse data systems. Furthermore, Khanna, et. al. does not make explicit reference to the processing architecture of GPU-based systems. This patent differs in the goal of commercial application, the structure and dimension of data being considered, the implementation, recommendations, and system architecture from the present invention.

U.S. Published Patent Application No. 2020/0311070 (Yan et al.) addresses the scalable deployment of natural language processing systems using LSTM. Yan, et al. focuses on language processing systems for speech and speech-based signals. While this does focus on the prediction of time-based data, it is structured and focuses mostly on speech and speech recognition. Yan et al. focuses on queries related to language processing systems. Yan et al. has a different scope and area of application than the present invention, which focuses on ensemble systems that are broader in application and are designed to work across multiple different types of systems. The present invention does not rely on a token-based infrastructure. Yan et al. is explicit in stating that the summary “not intended to identify key features or essential features of the claimed subject matter.” Yan et al. teaches a different type of architectural system that does not incorporate methods such as Markov Chain Monte Carlo and dynamic resource allocation. Furthermore, explicit details on processor architecture are not discussed and the application does not reference CPU, GPU, or other architecture. Yan et al. is materially different from the present invention herein in terms of scope, nature, purpose, application, and other areas.

U.S. Published Patent Application No. 2020/0310400 (Jha et al.) focuses on fault predictions using LSTM. This patent application uses LSTM methods and time series data to make predictions. However, the teachings of Jha et al. are explicitly designed and structured to characterize and predict system failures across machines and devices over time. Jha et al. is focused on understanding system states over time. Alternatively, the present invention addresses the problem of dynamically analyzing relationships across systems to determine patterns and trends that are not state-reliant. Furthermore, this system is inherently reliant on neural network infrastructure. The present invention is broader and uses more nuanced state-based systems. In particular, the present invention allows for methods such as Markov Chain Monte Carlo, which are not neural network based. Furthermore, Jha et al. focus on integrating data from sensors that monitor information over time, while the present invention is broader in the types of data collection receptacles that it supports. The innovation by Jha et al. differs in application, scope, design, and other ways from the present invention and, as such, is materially different from the disclosure of the present invention.

There are a wide variety of applications of LSTM in the prior art. Some of the most promising applications include generating captions and descriptors (Xu, Kelvin, et al. “Show, attend and tell: Neural image caption generation with visual attention.” International conference on machine learning. 2015), setting government policies such as tax rates (Zheng, Stephan, et al. “The AI Economist: Improving Equality and Productivity with AI-Driven Tax Policies.” arXiv preprint arXiv:2004.13332 (2020), generating recommendations on streaming services, and pharmaceutical applications such as predicting protein structures (Sønderby, Søren Kaae, et al. “Convolutional LSTM networks for subcellular localization of proteins.” International Conference on Algorithms for Computational Biology. Springer, Cham, 2015). There are numerous and varied applications of LSTM, and as such, this should not be considered a full representational of all prior art applications of LSTM but instead a highlight of some major areas of application and usage of LSTM-based procedures. Many of the applications and usage cases of LSTM are proprietary and or highly complex, and as such, this disclosure should be considered a discussion of the various ways in which LSTM is used, rather than a complete discussion of all possible ways in which LSTM has been deployed and implemented in the past.

### SUMMARY OF THE INVENTION

The present invention relates to a new business process system that uses innovative modifications and applications of machine learning methods to recognize patterns, structures, and trends over time. This is an improvement over previous methods such as Long Short-Term Memory (LSTM) applications that uses techniques and methodologies from fields other than machine learning such as mathematics, decision theory, optimization theory, and quantitative finance. The present invention applies Markov Chain Monte Carlo (MCMC) methods to coordinate and redirect assignments to focus on a solution. MCMC methods are used to analyze the LSTM routines to determine and synchronize the processor to reassign tasks in parallel to focus on a solution.

The improvements over existing methodology of the present invention provides for new and novel applications and improvements in business processes, such as:
More nuanced and in-depth analysis of relationship structures over time;
Analysis of asset liquidity over time in more detail than previously possible;
Extendibility and compatibility with Markov Chain Monte Carlo (MCMC) methods to allow for improvements in high-dimensional analysis;
A more in-depth view and understanding of how models work, allowing one to understand how components in the model are structured and interact instead of the traditional “black box” problem of having a machine learning algorithm whose behavior is not well understood;
Improvements in asset clustering performance;
Compatibility and modularity in design allowing for rapid deployment and integration into new systems;
Compatibility with attention-seeking models and systems; and
Other improvements and gains from combining multiple previously mentioned improvements together;
   In order to achieve the above improvements, the present invention contains several innovative components that allow for novel deployment and applications which include but are not limited to:
A new contextualization process for LSTM techniques that allows for new methods for information and data processing to operate in parallel rather than in sequence;
A new nested framework that, in particular, can take an LSTM model and extend it into new modeling classes;
A new linkage system that allows for improvements in efficiency and search in the LSTM optimization process, allowing LSTM models to “discover” new relationships that are normally hard to detect, even in an LSTM model;
New developments and applications of Markov Chain Monte Carlo in machine learning environments. In particular, the use of MCMC in understanding network architecture and in pruning random forest trees;
   The computer implemented system of the current invention utilizes machine readable code to perform the steps of:

1. Determining the relevant universe for the problem at hand. Collecting the appropriate data related to the universe for a given problem and store the data within a database in a format that can be defined.

2. Using data cleaning techniques to make the data reliable, standardized, and usable in data analytics processes.

3. Generating a structure for a hierarchy of artificial intelligence processes, with a top-level process at the highest level of the hierarchy.

4. Developing and deploying an artificial intelligence sub-process to be used by the top-level process. If appropriate, developing additional sub-processes in a nested n-stage decision process, where n is the number of nested sub-processes.

5. Utilizing a Markov Chain Monte Carlo (MCMC) approach to search across the high-dimensional model to look for trends and patterns across the data being analyzed. The MCMC algorithm shares information and resources across the ensemble to allow for improved computing and performance. MCMC is utilized for redirecting processor function to optimize the sub-process routines.

6. Implementing stochastic attention to the process to allow for added customizability and additional structural options.

7. Analyzing the resulting model to explore relationships between assets or create an interactive visual map of asset relationships across the high-dimensional space and display this map to the end-user.

8. Using the interactive map to elicit goals and objectives that are specific to the end-user. Analyze these issues specific to the deployment and goals of the end-user and present the end-user with the analysis in an interactive format that shows the current analysis and the state of the search.

9. Generating an interactive display for the user to interact with various visual components that allow for additional searches and refinements in the business process wherein the use may use data and analytics from previous searches to improve the efficiency and design in newly queried search processes.

### BRIEF DESCRIPTION OF THE DRAWINGS

The detailed embodiments have other features which will be more readily apparent from the detailed descriptions, the appended claims, and the accompanying figures. A brief introduction of the figures is set forth below.

FIG. 1 is a flow chart depiction of the structured ensemble systems using artificial intelligence-based methods that allow for dynamic user interfacing and interaction for decision making of the present invention;

FIG. 2 is a depiction of the manner of utilizing a LSTM sub-process in a random forest model in one embodiment of the present invention;

FIG. 3 depicts the process of utilizing a LSTM sub-process and MCMC search and allocator algorithm in an embodiment of the present invention utilizing the system in a 5-minute blitz chess game versus a computer; and

FIG. 4 is a detailed depiction of the asset rebalancer in one embodiment of the present invention.

### DETAILED DESCRIPTION OF THE PREFERRED EMBODIMENTS

The various steps set forth above will be described in more detail below with reference to the drawings. Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Although several embodiments disclosed herein are described with respect to analysis of network data and capacity management of computer networks, the techniques disclosed herein are applicable to other applications, for example various applications related to resource management in distributed systems or any computing system, analysis of storage capacity and storage management, analysis of server utilization and management of server configurations, and so on. Furthermore, the techniques disclosed herein are applicable to data collected from other sources, for example, trend analysis of user interactions performed by various users with online systems. For example, there may be a change in trend of user interactions caused by a system upgrade or a release of an application on a new platform such as mobile devices. The techniques disclosed herein allow detection of such trend and the change in this trend for reporting purposes as well as for recommending actions to be taken. For example, if an upward trend or a sudden upward jump is observed in user interactions, the online system may recommend increasing capacity of the servers processing the user interactions.

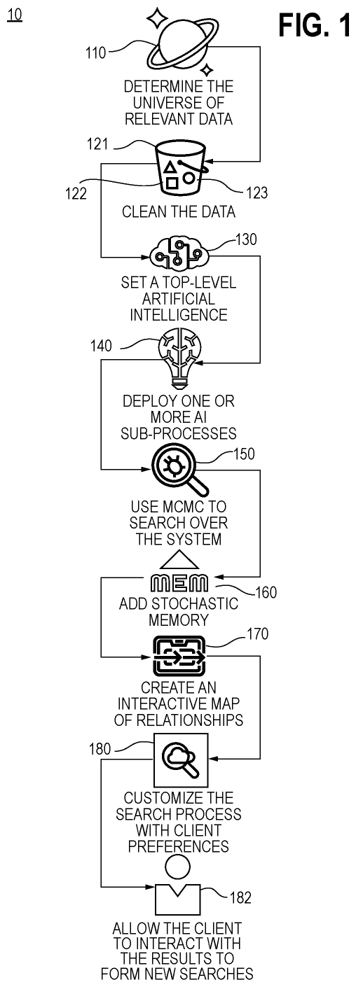

The first step in the process is shown in FIG. 1, determines the relevant universe for the problem at hand 110. The present invention has a database of information. Data is stored in the database based on the relevant universe of the data for the problem at hand. The present invention analyzes and uses the data stored in the database to make decisions, and as such, is dependent on the data being fed into the system. Determining the relevant universe of data involves understanding the particular problem that needs to be solved, the kinds of data needed to solve that problem, and issues associated with that kind of data. For example, when making a decision about allocating financial assets to make a portfolio, one may choose to acquire data from stock exchanges and from public filings to store in the database. Once the system has data loaded into the database, it must be analyzed to determine that the data is appropriate data for the analysis. At many companies, this often involves creating new containers for data collection and processing. For example, logistics companies often digitize and add autonomous tools to collect data across shipping processes to understand in real-time where delays are occurring. In the portfolio example, this may entail partnering and licensing data from an exchange or building tools to monitor exchanges in real-time. While often overlooked, making sure that the right data is collected to solve the desired problem at the start of the process enables all the later steps in the process to work properly. Poorly collected, inaccurate, or misleading data can lead to bad decisions and a false sense of security in the results being generated, and as such, this step should be carefully executed.

The second step in the process 10 involves using data cleaning techniques 120 to make the data reliable, standardized, and usable in data analytics processes. The data cleaning step 120 operates to determine if the data collected in the database of relevant data has not been entered in error 121, determine the data is scaled to the standard determined by the algorithm 122 and determine if the data is usable 123. The data cleaning step will convert data that is entered in error, scaled to an improper standard or unusable to a usable format or discard the data. Data cleaning techniques involve analyzing the data that was collected for errors, inconsistencies, and misreporting issues. Data collection often involves multiple types of data entry methods. Some data may be automatically collected by autonomous systems, and some may be manually entered. Manually entered data can contain typos and omissions, and sensors may be inaccurate. Data cleaning first involves checking for data entry errors 121. The system employs machine learning to automatically analyze and parse data to detect information that appears inconsistent with other data 121. Inconsistent information can then be analyzed to see if there was an error. Inconsistent data does not necessarily mean it is incorrect. For example, if one is using data on rainfall in a city, one day may have very heavy rainfall numbers because a hurricane resulted in increased rainfall. Determining what data to include and exclude is a complex and nuanced process and using machine learning and artificial intelligence to speed up this process is thus not a straightforward process because using only machine learning would potentially eliminate critical data. The data entry process must be analyzed for nuances and accuracy.

Once the data is cleaned from errors, it needs to be converted to be in a consistent format at scale 122. In the rainfall example, data from Atlanta might be in inches, while data from Berlin may be in centimeters. The cleaning step involves converting and scaling all the data so that it is in a consistent format. It is important to standardize the data in the universe of relevant data 110 collected in step 1. In many cases, the computer algorithm must take steps involving making decisions regarding what measurements to use, how to account for discrepancies in reporting, and what the biggest data consistency issues may be. For example, in finance, countries in the United States and Europe use two different accounting systems. One inquiry step of the algorithm may measure whether there should be corrections made to account for differences in reporting standards. It may be very costly to make many corrections for errors that may be quite small or immaterial. Furthermore, the accounts used to make the corrections may also be subject to different accounting standards, and they may need to be corrected. In addition, accounting standards often change, and as such, every year, new corrections may need to be implemented. As such, while resealing may appear to be straightforward can often be a nuanced and difficult problem to address. In order to address these issues, one can focus on usability.

The final component of data cleaning is usability 123. This is a concept that data should be in a format that can be accessed and analyzed. This means that the data that is collected should be collected in a way so that it can easily be parsed. Data parsing involves the processing of reading in data from a particular format to be used by a system. Parsed data is often reformatted so that it can be used by another system, and data parsing often happens multiple times throughout a system. As such, data should be collected in a way to allow for parsing. Usability thus dictates that ideally; data should be collected from data collection receptacles in a format that lends itself to parsing in commonly used industry-standard formats. These formats often include but are not limited to comma-separated files (CSV), zipped and compressed files (ZIP and RAR), relational table bases (SQL), standard image formats (JPEG and PNG), scalable files (vector-based formats), web-compliant formats (XML), simple text (TXT), and numerous other file types and formats. For many popular file formats, support is built into many systems for parsing. For some files, additional conversions are necessary. For example, image formats such as JPEGs are often converted into a matrix before being processed in a machine learning environment.

The third step in the process 130 involves parsing the collected data and structuring a relational table environment on a server. This step begins by reading the data into a second database system organized in tables. The resulting table format structure allows the system to quickly append new data, handle large volumes of data, and create customized data pulls. The second database organizational system allows for a massive data environment can be analyzed in seconds by only pulling data from the tables that are needed, rather than from a single massive environment. This allows for dynamic and modular data importing. If it is determined at a later stage of a project that certain data is missing, one can simply collect the missing data, detect that an update has been made to the database, and run an update query.

Data from across the data environment is parsed using parsing tools to convert the data into a collection of related tables that can be read by authorized users. These tables are stored on a server known as a SQL server, and administrators can process updates to the underlying tables as needed. Users and administrators can also log into the server to access the data through queries. Queries are submitted to the server, and the server then sends a resulting table to the user. This table can be viewed in SQL studio management software or can be directly pulled using many programming languages. Some cloud environments support advanced features such as computation in scientific computing languages on the SQL server itself, thus cutting down on processing time as the data does not need to be transferred across servers. There are also alternative storage methods that use languages similar in design to SQL to achieve comparable results.

In step 3 (130), a top-level artificial intelligence procedure is chosen by the system. In this particular system, multiple artificial intelligence procedures are used in unison in a process known as an ensemble. At the top of the ensemble is the top-level process, which directs and uses the lower-level processes to make decisions. In this step, the top-level process is chosen to use in the system.

The process of selecting a top-level process involves various high-level steps. In order to create a proper ensemble, the top-level process needs to be compatible with the sub-processes chosen. For example, if a top-level process assumes that stock returns are continuous and are a normally distributed process over time, then a lower-level process may cause issues if it assumes stock returns follow a discrete distribution such as a geometric process. Furthermore, the processes should be feasible. A top-level process that is computationally intensive using many nested sub-processes in an ensemble that are also computationally intensive may have difficulty producing results in a timely manner.

One example of selecting a top-level artificial intelligence of the third step 130 involves using a random forest algorithm as a top-level process. In a random forest algorithm, a decision tree is created using simple cut-offs. For example, a simple decision tree may say to purchase a stock if its price to earnings (P/E) ratio is under 10. Random forests build sophisticated trees from simple decision processes using machine learning to allow for a process that can become complex with enough branches in the tree. For example, in a more complex tree, the purchase recommendation first has a branch that checks if the P/E ratio is under 10, then checks if the company's revenue is growing, and then checks if the company is currently facing a major lawsuit. In the next step, a non-linear process could be composed that uses all of the previous criteria in unison. The non-linearity introduced here adds significant complexity to the underlying system and evaluates all the information in context relative to each other. In order to issue a purchase recommendation, the company would need to successfully pass all four of these checks, represented by four different branches in the tree. Typically, in order to make the process computationally feasible, the random forest algorithm uses simple decision rules but using an ensemble process, these decision rules can be replaced with more complex rules while also maintaining computational feasibility. With proper structure and insight, a decision tree can be generated that requires fewer branches, has fewer redundancies, and can be produced in a fast and efficient manner. This is because the right ensembles that exhibit high degrees of compatibility with random forest can lead to improvements in model design and efficiency. An example of such an ensemble process is discussed in step 5 and refined in step 6.

In step 4, one or more artificial intelligence sub-processes 140 are set below the top-level artificial intelligence 130. The top-level process 130 may use a sub-level process 140 to outsource some of the decision-making processes and estimation steps. For example, a random forest top-level process may take an LSTM sub-process. As an example of a nested process, a neural network may take a regression sub-process, which itself uses a regression subprocess in a process known as 2-stage least squares regression. In this example, there would be a 2-stage nesting below the top-level process. This nesting can continue with more layers, such as using a 3-stage least-squares regression with a top-level neural network.

As mentioned earlier, the top-level process 130 needs to be compatible with the lower processes 140. As such, the implementation is typically not straightforward. The system of the present invention may utilize a toolkit that contains proprietary technology to determine appropriateness based on many years of experience with building models and uses industry best practices in an autonomous system. The present invention generates improvements by having parts of the top-level process 130 run by sub-processes 140, which are more efficient and more precise in their estimation. Different models serve different purposes, and by combining them effectively in an ensemble, efficiency gains occur throughout the modeling procedure.

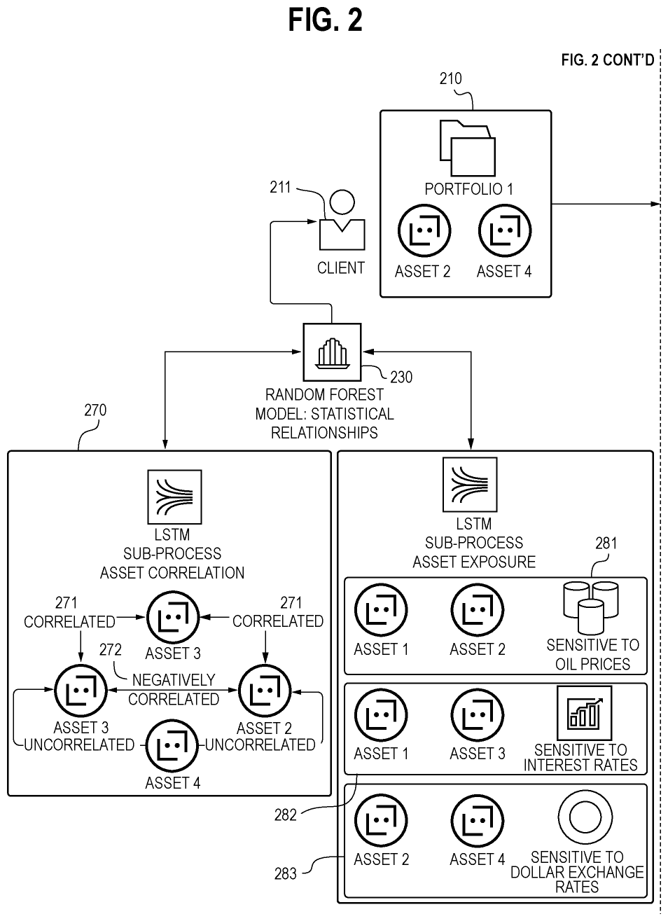

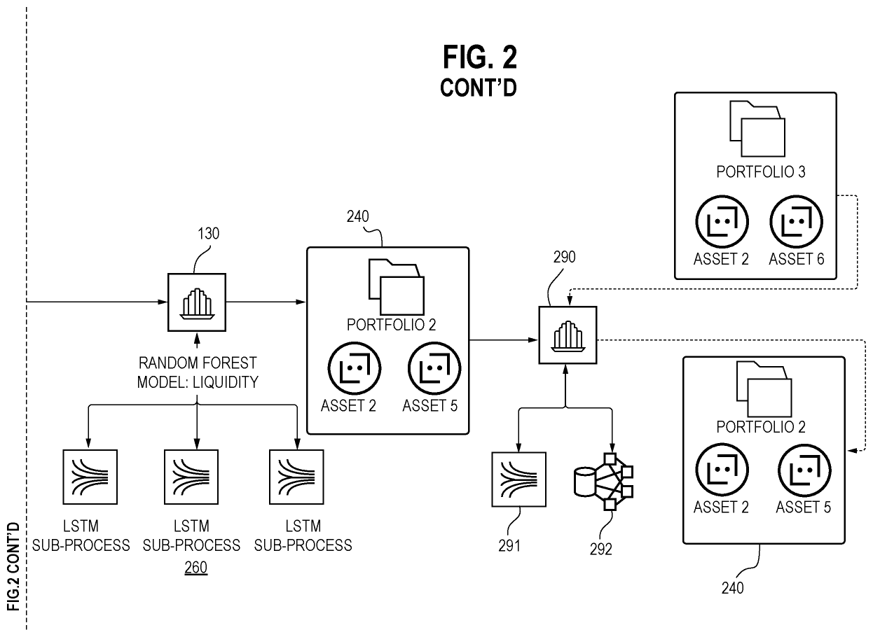

One particular example of an artificial intelligence sub-process routine 140 can be used as part of the example from step 4 using a random forest network with LSTM as a sub-process. In the random forest algorithm of the top-level artificial intelligence 130, instead of setting simple conditions, LSTM is first used to determine the relationship between the elements in the space. In an asset allocation example, this would determine the relationships between different stocks and bonds and characterize them over time. This sub-process 140 can be used to build investment rules, such as if several stocks are related to only invest in one of them as a hedge. This allows the investor to avoid added risk by mixing the exposures taken. In the example, should one stock drop in price, it does not imply that all the other stocks will drop, giving added diversification. In this example, using this information about stock relationships, the decision tree may have branches that check to see if one is invested in another stock before purchasing new stock in a portfolio. The decision tree from step 4 (140) could thus be modified using this LSTM process into a new tree. FIG. 2 shows a LSTM sub-process 140 as described below:
1. a random forest model top-level artificial intelligence 130 routine.
2. The system 200 uses an LSTM sub-process to build asset relationship maps.
3. The forest model top-level artificial intelligence 130 utilizes a plurality of LSTM sub-process 131, 132 and 135 to build a relationship map between individual assets.
4. The client 211 uses the random forest tree 130 to select an appropriate asset 212 and 214 for a potential purchase 210.
5. Repeat this process for other trees 220. Once the client 211 completes the use of many different trees, rather than make a recommendation on a specific asset, all assets that are selected and how often the selection occurs are condensed and passed onto a processor for analysis 230.
6. Use further random forest divisions to select the best asset among all the assets listed, using LSTM to extract and analyze features. The time-varying relation detection among LSTM can significantly improve detection over standard random forest algorithms and add depth and clarity.
7. Add the asset chosen from the analysis process to the portfolio.
8. Eliminate every asset that has a fundamental relationship with the asset, as determined by an LSTM process. Call this new list the first trimmed list.
9. Continue the process starting from the first tree, finding another appropriate asset from the first trimmed list. Repeat steps 4 to 6 on the trimmed list and select another asset. Trim the list again based on assets related to the new asset chosen.
10. On occasion, work backward up the list by adding trimmed assets back into the potential list and seeing if an asset that was added to the list of chosen assets could be removed for trimmed assets. This checks to see if the process could have violated global optimality.
11. Run until a portfolio is created.

The top-level process 130 and lower-level sub-process 140 nested processes are run together over time in a cloud-based parallelized computing environment. This allows for many sub-processes to run while still allowing the parent process to continue performing operations. As an example of parallelization, consider using a decision tree top-level process with a regression sub-process, a nested LSTM sub-process, and a further nested simple decision tree sub-process for the purposes of suggesting moves in a game of Chess. In this example, some of these processes will be processed first, and some will continue to run in parallel and update the parent process.

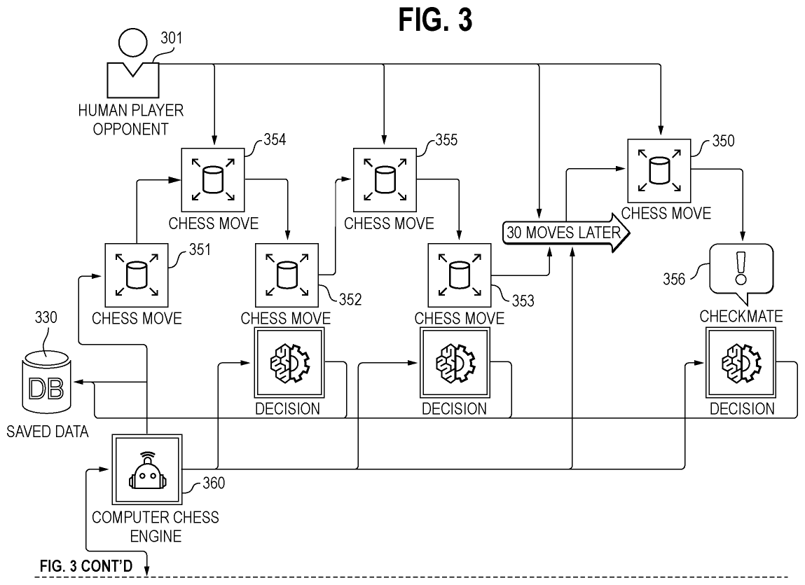

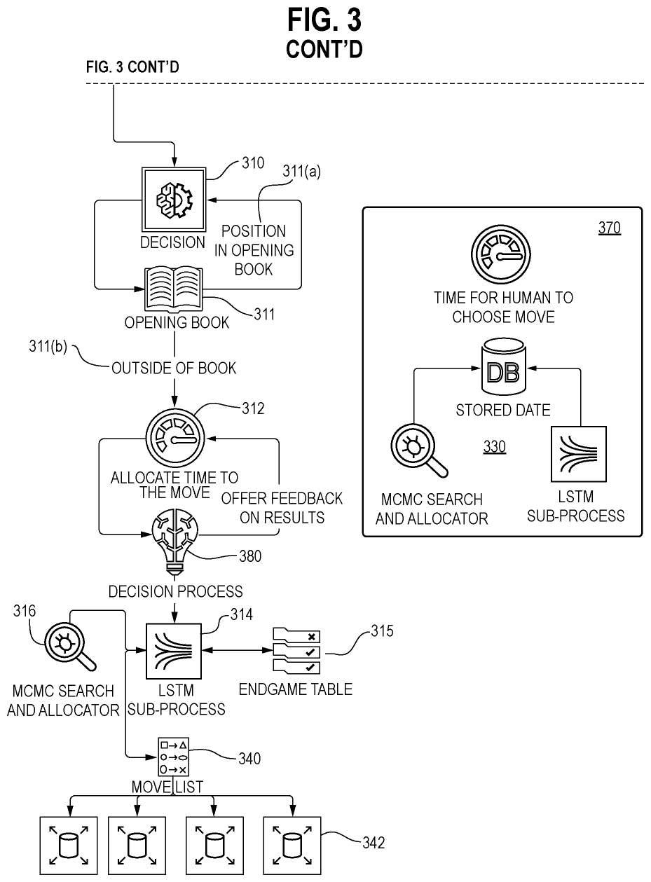

In the chess example of FIG. 3, the system uses a random forest process to decide on which move to make on a given turn. In this example, suppose the computer is allocated five total minutes to play a full game of Chess. The parallelized system may run as follows:
1. The program will first use the top-level decision tree 310 to decide on a move. The decision tree is a tree structure with the following priorities:
   1.1. The decision tree 310 has an “opening book” attached in memory. The opening book 311 is a list of strong openings that suggest what moves to make at the beginning of the game. If a game position arrives that is in the opening book 311; the computer has a move that it is directed to make that will occur automatically without further processing.
      1.1.1. Note that sometimes a game will “leave” the opening book, but a move can transition the game back into standard opening theory and result in a position that is in the book. As such, it is possible for a position to transition back into book.
   1.2. If the position is not in the opening book, the decision tree submits the game position to a regression program. The regression program estimates the number of moves needed to finish the game and allocates a certain amount of time to make a move 312.
   1.3. The regression sub-process sends the time allocation 312 to the LSTM sub-process 313. The LSTM sub-process 313 runs an LSTM algorithm on the position and looks at various possible lines of play. The more time is available, the more lines are considered, and the deeper the search. The less time is available, the fewer moves are considered. The LSTM sub-process 313 sends the results of its search up to the regression sub-process 314, and the regression sub-process 314 sends its results up to the decision tree. The decision tree 310 and the regression sub-process 314 share results between the process to determine if more time should be allocated towards a move. For example, if one move tends to score much better than the other moves, and there are no other strong candidates, the regression model may choose to make the move and save additional time. If no obvious move is found and there are several strong candidates, the decision tree 310 may suggest to the regression model to allow for additional time.
      1.3.1. It is important to note that this process is happening continuously. New results from the LSTM model are being fed into the regression process, which is constantly sharing results with the decision tree. As such, time allocation will constantly adjust.
   1.4. The final nested process is a simple decision tree. In addition to an “opening book,” the program also has an “endgame table base 315.” This is a pre-solved table that shows the optimal play in several endgames and whether an endgame transitions into a known winning position. If the LSTM sub-process 315 finds a position that contains seven or fewer pieces, it checks with the endgame table base 315 to see if it is a “winning” position. If the position is a known win, the program automatically chooses a line of play that leads to a win and communicates across the tree that a win has been found. If the computer believes it is behind and unlikely to win, it may also choose a forced draw line. The decision tree makes a determination when the computer is doing “badly enough” to justify switching to a forced draw.
2. As the system runs through the above steps, the output is displayed to the user showing the suggested move, the move the computer is currently investigating, the second-best suggested move, the computer's evaluation of the position (how far ahead or behind the computer is scored in “pawn equivalent units,” a chess position scoring system), how many different positions have been searched, the number of processors being used, and the hash table usage.
3. The above process can be parallelized (which is an important feature of the invention) and resources can be dynamically redeployed resources. For example, one processor can be assigned to the decision tree and one to the regression process. Two processors can be assigned to the neural network process. At different times in the analysis, a processor can be reassigned from the regression to the neural net, from the decision tree to the neural net, or from the neural net to check the endgame table. As such, processors can be dynamically moved to where they can be used the most efficiently to generate further gains.
   In the above example, the sub-processes 130 coordinating with the top-level process 140 can run independently. Instead of a five-minute time limit for a game, the process can also be run indefinitely (such as an “infinite search” that keeps searching the position until a winning endgame is found) or terminated early. In the early termination case, the program has a suggested move that it believes is the best based on the current analysis it has performed. The LSTM process may still be running, but the decision tree still has preliminary results it can use to make a decision. This means that the process proposed here is flexible in its application and deployment.

While the above chess example is similar to many current applications in the prior art, the system used herein is designed for use in many areas and is built to use data that can have a multitude of complex and non-trivial structures. As such, it serves as a non-trivial improvement and extension of the prior art. Furthermore, steps 6 through 12 serve to add layers of depth and complexity that further extend and improve the prior art.

Returning to FIG. 1, one of the innovative additions in the proposed business process is the addition of Markov Chain Monte Carlo 150 algorithms to the ensemble process from step 5. Markov Chain Monte Carlo (MCMC) is a high-level extension of Monte Carlo simulation to search a high dimensional space. In MCMC, a Markov Chain is simulated across transitions. This allows for the search of spaces that are difficult to characterize, view, or traverse. The result is that an MCMC algorithm 150 can add character and descriptions to statistical distributions or mathematical topologies that are too mathematically complex to easily describe or solve using traditional techniques. MCMC algorithms are highly customizable and can be built to serve various needs. For example, there are algorithms to search for high-likelihood regions across statistical distributions (such as estimating the maximum), algorithms to draw simulations (such as running several parallel chains and take every 10,000^{th} observation in each chain), and algorithms to explore the entirety of a space (such as a Gibbs sampler). In this process, the MCMC algorithms are customized to provide feedback by taking results from throughout the ensemble, feeding them into memory, and using them to analyze the space for trends. Once key results are discovered, the MCMC algorithm 150 feeds them back into the process to improve process flow and performance. This represents a new and novel application of MCMC across ensembles that is not part of the prior art. This MCMC deployment is modular in nature and is designed to be packaged and run in feedback and conjunction with the other ensemble processes, spreading information across the ensemble stack.

As an example of the use of the MCMC process, consider the previous random forest top-level process with an LSTM sub-process example. In the previous example, the random forest process had several branches that are built using LSTM. Suppose that each branch was an LSTM model that made a decision. With many branches, over time, the process would become slow and difficult to run but would be quite powerful. However, some branches may be redundant. As an example, consider the example of choosing a portfolio of stocks. One LSTM branch in the random forest may appear like an important decision, but the decision process may actually just be clutter and slowing down the process. For example, suppose one, upon further inspection, clearly would only choose a particular LSTM branch if a company's P/E ratio was under three, and its revenue growth rate was about 40%. However, this is found down a path focused on investing in growth companies, and analysis shows that there are no viable candidates that have both of these characteristics and are growth-oriented companies. Furthermore, the actual computational process is not as simple as “check whether the company has revenue under three and revenue growth rate above 40%” but is actually a complex loss function that, as it turns out, will only ever result in selecting the alternative path if both of these conditions are met. The process could be sped up by trimming this branch from the tree, as it only serves to slow down the analysis.

MCMC could be used in this example to look for branches like this. The MCMC simulation process would show that the branch in question would never be chosen, and as such, it should be trimmed. Trimming in random forest algorithms refers to removing branches from the tree to speed up computation. By analyzing trends and patterns, the MCMC algorithm could see which parts of the tree are most important and where most branches should be placed. Because these branches in the random forest-LSTM ensemble are not simple decisions but rather complex LSTM structures, trimming unwanted branches can lead to big improvements. Furthermore, adding branches in high-traffic regions can add a great deal of depth and specificity to the search process on the most important decisions. One should note that this innovation is a novel approach of MCMC, as the structure of the random forest has gained significant complexity by using an LSTM sub-process. MCMC allows one to understand and characterize the structure of the tree, and by using it for trimming, can add additional depth and understanding to the process. Furthermore, it can add clarity to the process as a whole and improve communication across the ensemble.

As seen across examples, all the processes in the ensemble tend to run in parallel and often need to be updated with the information the other processes are providing. However, it can be difficult to determine what information is most important to provide. In the random forest-LSTM example, the MCMC process provides information to the random forest algorithm about the structure of the various LSTM models being run and which branches are redundant, as well as how the different LSTM models are evolving. Meanwhile, it provides the lower level LSTM models with information about which relationships are the most important to consider and to monitor more effectively. In more complex examples, information can be generated constantly across layers, and it may not be obvious what information needs to be shared. For example, in the Chess example, how often does the remaining time left for analysis need to be passed down to the neural network algorithm? The MCMC process can help answer these questions by keeping a record of information that has been collected across the process, determining weights on which information has the biggest impact on the final decision, and sending that information where it needs to go at the right time.

The end result of this process is that MCMC is extended here to act as an allocator, choosing where to send information, how to send it, and when it needs to be sent. It collects data across the process and, as such, allows the process to operate efficiently. Furthermore, the MCMC process can re-allocate processors as needed. These processors will often be graphical processing units or GPUs. These GPU systems are more efficient for computing many machine learning problems, and recent advancements in GPU architecture have made the wide-scale deployment of GPUs systems and servers viable.

If it determines that a certain layer in the ensemble stack needs more processing and is slowing down results across the ensemble, it can re-allocate processors from components that are not as efficient to the more efficient layers. In particular, this dynamic re-allocation allows for LSTM methods to be used more efficiently by calling them to determine the most important relationships, spreading this information about the most important relationships to other layers in a stack, and then asking the LSTM methods to investigate certain relationships in more detail if they are found to play a significant role in the process and need further clarification. As an example, consider choosing a portfolio of stocks. The LSTM process may find relationships exist across several assets. The MCMC process may pull processors from LSTM computation once these relationships are found, find that many portfolios tend to include one of these chosen assets, and then ask the LSTM process to investigate one particular asset, asset A, in great detail, focusing just on relationships for that asset. After additional analysis, the MCMC algorithm may then allocate additional processors to exploring which assets are related to two particular assets, Assets A and B, and find that several assets are related to both of them. This may lead the MCMC algorithm to send information to an optimizer to avoid placing the assets found to be related to A and B in a portfolio that includes A and B. In this example, the MCMC algorithm directed how the processers should be allocated and, at what time, directed the different nested layers on what to investigate and search, shared results across the layers, and dynamically shifted the system on an as-needed basis.

Step 6 involves adding stochastic attention memory 160 to the business process. In step 6, an MCMC approach was adapted to add efficiency and direction to the system. However, an MCMC process itself can often benefit from a sense of direction. For example, an MCMC algorithm engaged in a search needs to begin the search process somewhere. The first runs of the algorithm are highly dependent on the chosen starting point, and a poorly chosen starting point can be problematic. As such, it is common for practitioners to choose a starting point, run several thousand (or hundreds of thousands and sometimes even more, depending on chain complexity) simulations, and discard these runs in a process known as a “burn-in.” As such, it can take some time and resources for the MCMC to begin generating refinements across the ensemble. This is because the algorithm needs to learn the contours and design of the shape to help guide the search.

Stochastic attention 160 can help speed up this process and cause the MCMC algorithm to make smarter choices across the system. Stochastic models are non-deterministic models over time, and an MCMC algorithm can be thought of as a model over time with each run of the chain (e.g., a simulation) being a point in time. The philosophy of adding a stochastic attention layer is that structure and insight is being added to the process, so the chain knows where to search, what information to prioritize, and how to most efficiently operate.

Stochastic attention models are a specific class of a stochastic process. In the attention models, certain data is retained and analyzed in-depth, certain information is analyzed, but not in-depth, and certain information is discarded. Rather than deterministically determining what information to retain, this is done stochastically. For example, suppose one is interested in picking stocks in a portfolio. The company's previous year earnings are a piece of information that is likely to be retained. The company's mailing address is less likely to material and may be cleaned as not being relevant in the initial cleaning of the data 120. However, it could prove that the mailing address may contain important information that was not obvious when the process was first run. The mailing address shows what country the company is headquartered in, and as such, in some stochastic attention simulations 160, the mailing address may be retained. In these cases, it may result that it is a useful piece of information in making a decision. It may be the case that the company's listed associated country may be different than where it actually operates for tax purposes, and the mailing address reveals important information about country-level risk. As such, miming many simulations and allowing for a couple where this information is retained can reveal surprising details.

In order to aid in making stochastic memory retention decisions 160, the stochastic attention process can admit certain model structures and assumptions. In other words, the system can impose certain restrictions on the process, for example, by assuming that the resulting model must be linear or that a company's PIE ratio must be retained. Poorly specified and structured models can be problematic, but in some cases, there is reason to force a certain structure. For example, in quantitative finance, stochastic models are often built by sophisticated institutional investors to model an asset's price. These sophisticated stochastic models can thus be restructured into a stochastic attention model, forcing certain variables to be retained, certain variables to be discarded, and forcing the resulting model to have a certain structure. Models that do not have an appropriate structure would thus be dropped from the MCMC search space, and the MCMC search process would not allow the ensemble to investigate possibilities in that region. In the example of a chess game, this would involve an MCMC model not being permitted to investigate certain moves, such as certain queen sacrifices.

The general philosophy behind adding stochastic attention layers to an MCMC process is that by adding context and information from years of experience and research, the MCMC process can be sped up to focus on the areas that are deemed important. The stochasticity can be customized and parameterized to allow for a certain amount of deviation from the imposed structure, allowing the MCMC algorithm some degree of flexibility while also keeping the process efficient and focused. The innovation of adding stochastic attention to the MCMC process adds contextualization and significant improvements to model performance by incorporating real-world information, quantitative and qualitative insights, and research that firms have developed into the ensemble process. The result is that the MCMC information-spreading process can be made more reliable, be less likely to enter inefficient regions and become more consistent. Because the proposed ensemble innovation is quite dense and complex, adding specificity to MCMC to make it more consistent is an important improvement that allows this present invention to be used at scale without constant oversight, and as such, makes it commercially feasible and deployable rather than merely a theoretical improvement.

Once step 6 is complete, a process is in place that can be run and generate results that update over time 170. As these results are being generated, they can be passed on to the end-user visually to show the state of the search and what results are being generated. In step 7, these results are visually displayed to the end-user in an easy-to-understand format.

The ensemble process built can be complex and difficult to understand. For example, machine learning algorithms are often nuanced, and it can be difficult to back-trace the results and why they produce certain results, known as the “black box” problem of machine learning. The MCMC refinement to machine learning and the LSTM approach allows for the contextualization of these results and a map of how different parts of the process are related. In step 8, this map is configured to be displayed to the end-user 180. This shows the different dimensions that are being analyzed—the regions that are being searched, for example—rather than the layers being analyzed. For example, in a chess game, this would state what moves and lines of play are being analyzed, rather than how the processors are being allocated. Each line of play can be thought of as a dimension being analyzed across the layers of the system.

The most important parts and dimensions of the map are first shown to the user 180. This is done visually with a dimension selection tool and descriptions of some of the characteristics and importance of each dimension. The user can then switch between different dimensional views to view different dimensions. In the standard layout, up to 3 dimensions can be viewed at a time as a three-dimensional graph that can be rotated. These visual results are updated over time and are designed to show the most important information to the end-user. This allows the user to see a complex, nuanced process in an easy-to-understand manner while also allowing sophisticated users to switch between dimensions for a more nuanced view.

Consider the asset allocation example. Suppose the process finds that the most important dimensions are the P/E ratio, the company's market capitalization, and the company's revenue growth rate. These three dimensions will be displayed by default. The algorithm is currently searching through the P/E ratio dimension for interactions with other dimensions, and as such, the process will also inform the user that the P/E dimension is being examined in more detail. The user, if desired, can also see that this dimension is being investigated concurrently with other dimensions, for example, P/E being investigated in relation to research and development costs. The process will also visually show what other dimensions are important. For example, the dimension “dividend payout ratio” may be quite important, and the user may switch between revenue growth rate and dividend payout ratio. This process would then show how different stocks are related and the risks associated with a given portfolio. For a chosen portfolio, as the MCMC directed process continues to gain more information, additional information about the risks will continue to be added to the diagram to give the user more information about the portfolio he or she selected.

The end result of this process is that the map shown to the user will guide him or her in understanding how the search process is developing over time 180. This will aid the user in making decisions such as how long to run the search, when to cut off the search process, how the different dimensions are related, and how the search process is developing. Advanced users can opt to see how processors are being allocated across analytic layers and the current state of the MCMC information matrix. This visual guide serves as an important roadmap for traversing the ensemble and offering user-guided decision making.

The interactive map from step 7 (170) also serves as a map for further analysis in step 8 (180). In this step, the user 182 can interact with the map to guide the analysis in a certain direction. If a user is interested in a certain region or result from the data being presented, he or she can send a command 182 to the program 180, and that area will be investigated in more detail. Once the command is sent, parallel computing allows for a processor 180 to be reassigned to start investigating this region. This process takes the processor that is deemed to be performing the least critical analysis and starts a new MCMC chain with initial parameters chosen by the user's selection. This takes the user's selection to determine the direction and area the chain will explore, and this then feeds data into the process.

Consider the asset selection example FIG. 2. If the user selects a certain stock to be in the portfolio, then the search process will be updated, and new chains will be created to investigate portfolios with this stock 240. The information from the past searches is still retained, but the focus shifts on portfolios containing the chosen stock. This is a common example in many real-life applications where a client wants a portfolio that contains a certain stock. Furthermore, the client may choose to exclude certain stocks he or she does not want to own. These results are passed to the MCMC system, which creates new chains 250 to search the regions that are most important to the user.

As the system gains more feedback on the process, more information will also be passed on to the user, and his or her interactive map will continue to update. Users can then submit more detailed information via the map, which will further enhance the search. This allows the map to function as more than just a visual map, acting as a guide to the ensemble. The result is that the process can be focused to explore the topics most important to the user and inform the user about the most important considerations and what areas to explore in more detail, guiding the user to make better decisions.

This interactive map 170 represents a significant performance improvement over the prior art. There is ample evidence to show that combining analytics with human insight leads to better insights. Human grandmaster chess players playing with a chess engine tend to produce better results than grandmasters without an engine or engines alone because they know how to interpret the results and insights the computer produces and understand when the computer program may be running into technical issues. This is also seen in machine learning, where machine learning algorithms engaged in picture recognition will often think a picture showing a certain image when it clearly does not. For example, a picture that is random static may be thought to show a certain kind of animal.

The current trending theory for the gains from human insight is that sophisticated algorithms tend to produce better insights than humans almost all of the time, but that advanced users can spot when an algorithm has gone off course by understanding how the algorithm runs. As such, combining human intelligence with an ensemble system through an information-processing interface via an interactive map can lead to improvements in performance across the system.

The ninth and final step involves choosing to save some of the results to improve future applications of a given ensemble. The data from the search and analytics process is saved, and features regarding the parameters chosen are stored. If a similar search is run again in the future, the process can simply grab the relevant information stored in memory and skip much of the initial calibration. This is similar to how a neural network trains itself, but different in design and scope. Rather than re-training to work on similar problems, this is training to work on new problems using results from a previous analysis.

This process involves storing information and data from each ensemble run and then running the parameters and information obtained through an LSTM process. The LSTM process can then detect trends and patterns over time to see how the user's desires and preferences are changing. Once these patterns and trends are understood, the LSTM model can help make decisions about what data to retain between model runs by using traditional LSTM memory gate architecture. This involves letting the LSTM process “forget” some information between states and only retain what is needed. In this application, this involves choosing what data (stored as a matrix) should be retained. The result is that when a new search is run, the process is already calibrated, and time can be saved in MCMC calibration and search.

As an example of how this innovation compares to the prior art, consider a Chess engine playing a game of Chess. After each move, the analysis can be saved regarding what the engine thought about each particular line of play 330. After its opponent moves, the computer can discard the analysis for the lines that weren't played and focus on the line that was played (so if the computer was looking in detail at three different possible continuations after it made a move, it could discard the analysis from the two continuations that were not chosen assuming the third was chosen. If another move is played, then the computer can search in more detail using the limited processing it spent on alternative moves). This is quite common in many advanced AI systems and involves efficient coding of memory and storage usage. The present invention extends upon this by looking at trends across many moves and games 350. In the chess example, the program would look at which moves were played against the computer engine 340 and why these moves were chosen 342. Instead of simply learning to find winning strategies using a neural network, this would instead determine what information could be saved and used over the next game. In this example, after the game is over, the program may notice a trend, such as its human opponent preferring to play piece exchanges and plays into positions that tend to be closed (closed here means positions where it is difficult to move pieces around the board). If this is the case, then the engine should anticipate that certain positions are more likely to be played and place additional emphasis on analyzing these positions. Furthermore, the engine would try to avoid these types of positions (since its opponent is more familiar with them), and if it is trying to decide between two moves that appear very similar in terms of evaluation to choose the one that leads to more of an open board position with fewer piece trade options. This would also lead the program to choose different positions in the opening book.

The difference in the example from the prior art is rather than learning broad strategies and ideas; in the example, the Chess program learned about the preferences of its opponent and how to play given these conditions. This is similar to how an asset management program could learn what its client's preferences are and make different recommendations accordingly.

In some cases, due to privacy reasons, legal restrictions, or a multitude of reasons, the user would prefer for their data to not be saved or recorded. In this case, the LSTM process is modified so that instead of saving information across each step, none of the information is retained, and the resulting matrix is an empty 0 by 0 matrix, which contains no user data. This allows for compliance with data privacy regulations and confidentiality restrictions and can be considered a special (and trivial given that no data is retained or made available) LSTM case. U.S. patent application Ser. No. 16/548,505 (Kotarinos and Tsokos) addresses overall portfolio structure and asset allocation. While this previous filing focused on constructing a portfolio in its entirety over multiple criteria, the application focuses primarily on understanding and dissecting liquidity across multiple dimensions. As such, it differs in scope to the previous filing and while is a similar work is not a continuation of the previous patent application.

There are several notable applications of this business process. The first, as noted throughout the summary, is in asset allocation. This ensemble process can be used to find relationships among assets over time and cluster them by using different layers. It can then be used to select optimal assets using another layer from these clusters. A top-level layer forms a utility function (a rank-ordering of assets) and uses this utility function to determine which assets to iteratively add or drop over time from the portfolio. U.S. patent application Ser. No. 16/841,024 (Kotarinos) addresses methods to rebalance a portfolio and notify a user about the current state of his or her assets. This primarily focuses on suitability of assets. The proposed innovation focuses on liquidity and the rebalancing and adjusting of a portfolio based on liquidity concerns. These concerns and rebalancing recommendations are generated by a different procedure from application Ser. No. 16/841,024 and are different in scope. U.S. patent application Ser. No. 16/841,024 is incorporated by reference in its entirety to the same extent as if the disclosure is made as part of this application.

The asset management system can also use a parallel ensemble process that focuses on rebalancing assets. This ensemble analyzes a client's desired portfolio and their current portfolio and looks for the best way to change over assets. While rebalancing may appear straightforward, this ensemble handles the tricky steps by understanding the data across time and the user's preferences. For example, suppose the client has too much stock in a given company, but the company is a good fit. This asset's percentage allocation may be too high in absolute terms but would be a lower priority to rebalance than an asset he or she is holding that is a small part of the portfolio but a complete mismatch to his or her risk preferences. An asset that is a poor fit but not a complete mismatch may be rebalanced later due to the size of the holding being relatively small. Understanding rebalancing order could be done by understanding how the assets in the client's current portfolio are related over time and building a layered ensemble to make recommendations about rebalancing order and priority.

One particularly interesting application of this process is using a Data Shapley layer and an LSTM layer. Data Shapley is a technique for understanding the role and relative importance of each piece of data in the decision that was reached. By using Data Shapley, the LSTM layer can more accurately measure the impact a piece of data is having and evaluate whether it should be retained or forgotten. Furthermore, by switching the layering and putting Data Shapley above LSTM, one could use LSTM to more quickly determine more quickly which pieces of data should be explored and analyzed by the Data Shapely process and which can be excluded, which under the right conditions can improve Data Shapley estimation times. This has particular applications for making financial decisions for trusts and large groups of investors, as many different pieces of information need to be compared over time. U.S. patent application Ser. No. 16/790,291 (Kotarinos and Tsokos) focuses on a digital system for making assignments across money managers. In the proposed innovation, this system focuses on liquidity of assets. The application of the present invention can be used in combination with the applications disclosed in application Ser. No. 16/790,291 to make an allocation to different money managers that takes into consideration the liquidity of investments made. This is a particularly innovative combination as money manager allocations are typically not analyzed in regard to the liquidity constraints that occur from using certain combinations of money managers in joint combinations. U.S. patent application Ser. No. 16/790,291 is incorporated by reference in its entirety to the same extent as if the disclosure is made as part of this application. A similar application focuses just on multi-user decision making. In this process, an LSTM layer determines the most important features and trends over time. A higher layer uses a Democratized Voter System (DVS) to present information from the LSTM process to multiple stakeholders. In a DVS, each decision-maker enters their preferences and desires into the system, and the system makes a decision by taking the preferences of every decision-maker into account. As an example, this system allows trusts and endowment funds to make allocation and investment decisions on behalf of others. The DVS system can use an LSTM layer to determine what are the most important trends and features over time in a stream of data, then present these to the stakeholders. For example, trusts could be asked about their preferences over risk and what to do with asses during a recession before a recession begins, and as such, when signs of a recession starting occur, the asset management system would then know the beneficiary preferences ahead of time, instead of waiting to ask for their desires. This can be important when time is of the essence, such as in financial markets, health care, and advanced manufacturing processes. Combining an LSTM layer with a DVS top-layer or a more complex layering process with a DVS-LSTM stack can lead to improvements in decision making time and efficiency in multi-user systems. U.S. patent application Ser. No. 16/824,998 (Kotarinos and Tsokos) focuses on a method known as a democratized voter system with applications to trusts and endowment funds. This system has useful applications when making a decision on behalf of one or more users. The proposed innovation focuses on liquidity for one user. However, it can be used with multiple users by using some of the technological innovations included in patent application Ser. No. 16/824,998. As such, the disclosure of patent application Ser. No. 16/824,998 can lead to some unique applications and features when used in concert in a system.

Similar to the asset management example, this can also be used to assign money to asset managers and oversee the allocation process to asset management groups. This involves creating a new layer designed in the asset management example for assignment and monitoring to money managers. Rather than simply assign to money managers, this observer their performance over time and looks for trends in money manager performance. Using an LSTM layer, this can monitor a money manager's performance and make recommendations based on how he or she is performing in terms of returns over time. As an alternative, this process could instead use a Poisson Process layer in place of an LSTM layer. The Poisson process would monitor if the asset manager is improving or worsening the portfolio's performance over time. If the money manager is unable to improve the portfolio's performance or is worsening it, the Poisson process layer can pass additional information up to a decision model that decides based on the Poisson process layer recommendation.

Another example of this ensemble process is using a Sharpe ratio layer combined with other layers to make decisions about portfolio allocations. The Sharpe ratio is a standard financial ratio that measures a portfolio's return for a given level of risk. This ensemble approach extends the Sharpe ratio approach by using it in conjunction with other decision-making approaches. For example, the Sharpe ratio could be one layer, and there could be a parallel layer that uses a DVS to make an allocation suggestion. This parallel layer approach extension of the business process allows for a top-level decision process (such as a weighted regression matrix) to take results and suggestions from competing lower-level processes and use them to make a decision. This approach is especially effective when the lower-level processes exhibit some degree of orthogonality and compete with each other by using different perspectives and methodologies. U.S. patent application Ser. No. 16/829,139 (Kotarinos) uses multiple different decision-making perspectives to make asset allocations. In this system, rather than using multiple decision theory frameworks the proposed innovation uses multiple different kinds of analytical processes in an ensemble. This proposed innovation also has a different architectural structure, as patent application Ser. No. 16/829,139 focuses on mixing different methods together. In particular, in patent Ser. No. 16/829,139 the stacked layer is of dimension at most two, with one high-level method and lower-level methods at a single stack layer. The result is that processes in the lower level must be mixed together and blended, rather than being allowed to operate jointly. This eliminates the analysis of interactive effects within the layer. These patents can be used in combination to allow for scalable and computationally efficient deployment of multiple analytical systems and multiple decision-making processes in a single deployable environment. U.S. patent application Ser. No. 16/829,139 is incorporated by reference in its entirety to the same extent as if the disclosure is made as part of this application.

Another application of note is using this system to analyze asset liquidity over time. Using LSTM, one could analyze patterns and trends to see what assets tend to trade at similar times. By doing this, one could use an LSTM layer to determine possible liquidity relationships over time. Once these liquidity relationships are known, a higher layer in the process could recommend asset mixes that address liquidity concerns in the portfolio. A parallel ensemble process can also make rebalancing recommendations using an ensemble process to use the LSTM results to understand liquidity risks and how to rebalance a portfolio to avoid them. This can also be incorporated into other systems, such as a liquidity LSTM layer process in an asset allocation preference system.

FIG. 1 shows a step-by-step flowchart of some of the steps in the present invention. The process begins with determining the appropriate universe for analysis 110. Once that is determined, the data is cleaned 120 to allow for consistent analysis. This allows for setting and configuring various artificial intelligence systems in a hierarchy. The step of setting a top-level artificial intelligence 130 to deploy one or more AI sub-processes 140 is utilized to set the AI hierarchy for a specific task.

Once the AI hierarchy is set 140, the resulting system can be analyzed using Markov Chain Monte Carlo 150. One may then if so desired, add stochastic memory analysis 160 to the system. Once the analysis is complete, an interactive map 170 of the relationships in the data is created and presented to the user. This can be customized 180, and updates as the user interacts 182 with it to show additional relationships based on the needs and the desires of the user.

FIG. 2 shows a simplified example of a combination using a random forest process with the LSTM sub-process 130 in a decision framework for stocks trading on an exchange 200. In the first stage of the process, a random forest model 130 looks for statistical relationships across the data 210. An LSTM sub-process 260 is used to analyze correlations among several assets. In particular, the process finds meaningful relationships between assets 1, 2, 3, and 4 (270). Asset 1 is positively correlated with assets 2 and 3 (271). Meanwhile, assets 2 and 3 are negatively correlated 272, and asset 4 is uncorrelated with assets 2 and 3. For example, suppose asset 1 is a supplier, and assets 2 and 3 are rival firms using assets manufactured by asset 1. These assets may exhibit such a relationship. Meanwhile, asset four could be in a different market and, as such, is uncorrelated to assets 2 and 3.

Another LSTM sub-process 280 analyzes the data to determine relationships involving asset exposures. Assets 1 and 2 are seen to be sensitive in trading prices 281 to changes in oil prices, assets 1 and 3 are sensitive to interest rates 282, and assets 2 and 4 are sensitive to exchange rates 283. In our example, asset three may have oil price exposures with a futures contract, but the companies representing assets 1 and 2 did not and, in an industry, sensitive to oil prices. If companies 1 and 3 used debt to finance growth, they may also be sensitive to interest rates. Meanwhile, if assets 2 and 4 operate out of a foreign country, they may have an exposure to interest rates.

The results from the random forest algorithm are analyzed and used to select an initial portfolio for the client, resulting in the selection of assets 2 and 4. This is represented by portfolio 1 (210). These results are then passed to another random forest process that analyzes the portfolio liquidity 130. The liquidity analyzer uses another set of LSTM process to analyze liquidity concerns among assets. The liquidity finds that asset 5 is similar to asset 4 but has a better liquidity mix with asset 2 and recommend 5 as a replacement for 2 (240). This results in a new portfolio suggestion, portfolio 2 (240).

These results may then be passed on to yet another random forest process 290, which uses an LSTM 291 process and a K-means clustering algorithm 292 to suggest portfolio rebalancing orders. The client's current portfolio of assets is represented by portfolio 3 (250). This portfolio is passed through the random forest rebalancer 290, which suggests the steps taken to reach portfolio 2. The dotted line shows the transition that occurs from portfolio 3 (250) to portfolio 2 (240), which occurs via making transactions suggested by the random forest rebalancer process.

In this example figure, multiple different types of random forest processes are used with different kinds and numbers of sub-processes. The choice of which process to use in each step is determined by the needs of the individual process that is being implemented. By breaking down a complex problem into more manageable steps, modular and rapid development and implementation can be achieved, allowing for lower development costs, more agile systems, and scalable business process solutions.

FIG. 3 shows an example of several layered processes working together in unison at once in a Chess game. In this example, a human 301 is playing a computer in a blitz Chess game 300. A blitz game is a game where each player is given five total minutes of time to decide on moves. If a player runs out of time or is checkmated, he or she loses the game.

In this example, the computer has the first move 351. The computer 360 first checks the game position and sees if the position is in the opening book 311. An opening book 311 is a pre-written database of positions and suggestions for possible moves in each position. These are typical openings and lines of play that are evaluated ahead of time and believed to be strong lines of play for a given position. These books 311 vary in size, but due to the high combinatorial nature of the number of positions, sooner or later, the game will eventually transition outside of the book. As long as the position is in the book, the computer will always know what to play and can play a “book move.” 311(a)

Once the position falls out of the book 311(b), the chess program 310 will use a regression program to allocate time to the move (312). The program will be given an initial allocation of time 312 for the move, say 15 seconds. The decision process 380 is then sent to a sub-process 314 to look at the available moves 340. The sub-process in this example uses an LSTM analyzer 314 combined with an endgame table 314 and an MCMC process 316 to move processing resources across the LSTM analyzer 314. In the example move shown in the process, the analyzer is looking at four different possible moves 342. This is a process known as trimming where many possible combinatorial moves are narrowed down to viable candidates, with moves that appear to be dubiously removed from the search.

In addition to the move analyzer 314, an endgame table is attached 315. An endgame table 315 consists of positions analyzed in advance for certain ending positions, often including up to 7 total pieces. These tables show “perfect play” for the given position and can quickly show whether a position will transition into a known win. If a computer program can force a position to transition into one of several known wins, this results in a combination of moves that will lead to certain victory for the computer engine. This is known as a “forced win.” If one of these is discovered, the search process 314 will be updated to choose the known forced win, and the MCMC process 316 can shift resource allocation to forcing moves along the known win rather than spending additional time analyzing positions.

Once the process determines that no further time will be allotted, either by using up the allotted time 312, being in a position found in the opening book 311, or discovering a forced win via the use of the endgame table, the move is submitted. The data from the analysis is stored in memory 330. While the player is thinking about his or her move, the computer will continue to analyze the position 370. The computer may have analyzed certain lines and found a move to be favorable. The computer will discard analysis from lines not chosen, and then continue to analyze the chosen line. After the player moves, the computer will discard lines of analysis that are no longer needed and continue its analysis on the chosen line. For example, suppose the computer is choosing between moving a rook two spaces forward and moving a rook three spaces forward. Once the computer decides to move the rook two spaces forward, the analysis for moving the rook three spaces forward is discarded. The computer then analyzes lines resulting from this move further. If the human player decides to take the rook with his queen, then lines involving other combinations (such as castling) are no longer necessary and discarded. The MCMC allocator 316 and search process continues to run while the player is deciding on a move.

In the given example, the computer makes three moves 351, 352 and 353, and the human player makes two moves 354 and 355, for a total of 5 moves being made. After this period has elapsed, the arrow denotes that an additional 30 moves are made. After this, the computer will have made 18 moves, and the human will have made 17 moves. The human then makes his or her 18^{th} move. The computer's 19^{th} move results in checkmate 356 and the game ends. Each of these moves follows the same process as the given example move, with the computer checking the opening book 311, allocating the move for further analysis, using the MCMC process 316 to update information and redeploy computing resources while the human considers his move 370 and while the computer considers its own move, and finally submitting a move 351, 352 and 353.

In this example, the process continued until the player was checkmated. The process may also end without a checkmate if the human player runs out of time or if the game ends in a draw. The computer program 360 could also be given a position and be tasked with analyzing the position indefinitely. In this process, the computer engine will keep evaluating a position and searching through different possibilities. This will typically continue indefinitely unless the position is combinatorically very close to a position in an endgame table that will quickly transition into one of a few known positions in the table. In the case that all known combinatorial positions are analyzed (which may be possible in an 8-piece game that quickly transitions into a 7-piece game), the engine may end its analysis early and present the optimal play result suggestions.

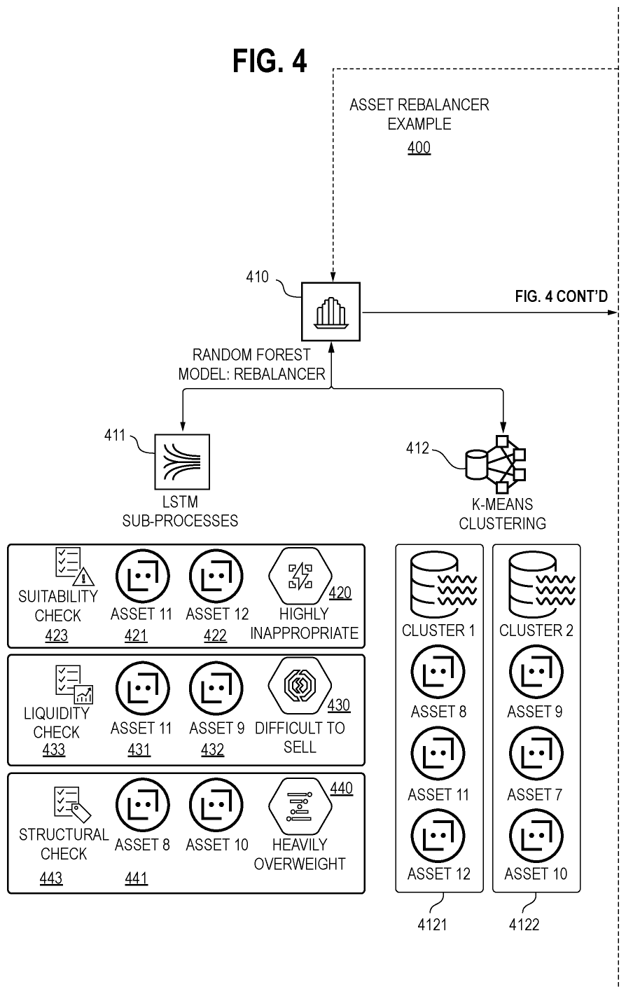

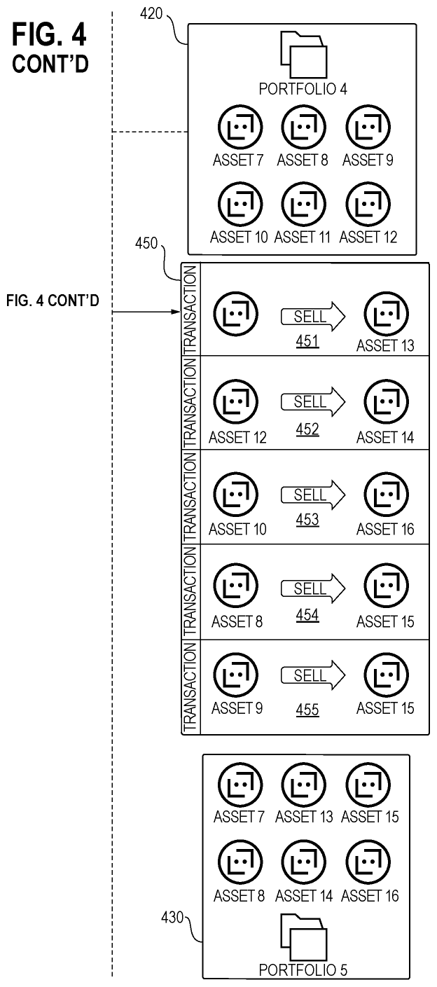

FIG. 4 is an asset rebalancer process 400, an example of the combination of multiple LSTM sub-processes 411 with a K-means clustering process 412 for asset rebalancing. This example shows many assets and more details than the information shown in FIG. 2, which concludes with only needing to rebalance two assets.

In this example, the current portfolio, portfolio 4 (420), contains six assets. The desired portfolio after rebalancing, portfolio 5 (430), contains six assets as well. The goal of this process is to convert a portfolio containing the six currently held assets into a portfolio containing the six desired assets and to convert the asset holdings to the appropriate weights.

The random forest process 410 is used to generate a series of steps to be taken to rebalance the portfolio. In this example, the three different LSTM sub-processes are used. The first LSTM sub-process 420 looks at trends across time to evaluate how suitable a given asset 421, 422 is for a portfolio. The LSTM sub-process runs a suitably check 423 on the assets 421 and 422. For example, the process may find that the asset is too volatile and has too much risk for a given client. This sub-process suggests assets 11 and 12 should be removed.

The second LSTM sub-process 430 conducts a liquidity check 431 on a given assets 431, 432. Liquidity is a measure of the degree of difficulty in converting the asset into another asset. Some stocks are very liquid, while some are thinly traded, and as such, it can be difficult to convert a large position. In this example, the liquidity analyzer flags liquidity issues with assets 9 and 11.

The third LSTM sub-process 440 conducts a structural check 443 on assets 441, 442 to detect any issues with assets 8 and 10. These two assets may be found to be heavily represented in the portfolio relative to other assets. Even though asset 8 is also in the final portfolio, the client was determined to have held too large of a position in this asset, and some should still be sold.

The LSTM sub-processes 423, 433 and 443 are combined with a K-means clustering algorithm 412, which finds structural relationships between two asset families 4121 and 4122. The K-means clustering process could, for example, form clusters using results reported in quarterly filings regarding profitability and leverage and form clusters based on this data. In this example, after running a K-means clustering algorithm, assets 8, 11, and 12 are clustered together into cluster 1, while assets 7, 9, and 10 are clustered into cluster 2. The K-means clustering algorithm would suggest that if one needs to sell an asset in one cluster to look too similar assets in the same cluster as replacements, and to consider prioritizing transactions that involve buying and selling assets in the same cluster.

The results from the four sub-processes are combined and turned into a series of five suggested transactions 450. The first suggested transaction 451 involves selling asset 11 and purchasing asset 13. Asset 11 is highly inappropriate for the investor, and the high liquidity makes it relatively easy to sell 11 and purchase 13. The second suggested transaction 452 involves selling asset 12 and buying asset 14. Asset 12 is also inappropriate, but it may be more difficult to make this transaction, and it may take longer to execute due to liquidity constraints.

The next two transactions 453 and 454 involve selling assets 10 and 8. While asset 8 is in the final portfolio, it is overweight in the initial portfolio, so some of this asset should be sold. In this example, these assets are sold for positions in assets 16 and 15.

The final transaction 455 involves selling off holdings in asset 9 to purchase asset 15. This transaction is considered the lowest priority transaction, and liquidity issues may cause this transaction to take longer to complete.

In the above example, the ordering and rebalancing of asset changes vary. While suitability issues appear to be the most severe, liquidity is more nuanced and varies in severity. While at first glance, the process may seem as simple as selling one asset and buying another, ordering and priority are important. A portfolio that is rebalanced too often will often incur expensive exchange fees and will be volatile and unstable, while a portfolio not rebalanced often enough could result in assets that are a poor fit. Having a system to suggest rebalancing steps and trading off different criteria through different sub-processes is, as such, a useful business process. In this example, three different LSTM sub-processes and a K-means clustering sub-process were used. Other applications and deployments can use other different method mixes based on the structure of asset holdings and preferences of the client.

It should be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations may be used by those skilled in the data processing arts to convey the substance of the work effectively to others skilled in the art. These operations, while described functionally, computationally, or logically, are understood to be implemented by computer programs or equivalent electrical circuits, microcode, or the like. The steps described are complete and impossible to be performed by a human. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for generating the structure of an ensemble system using artificial intelligence-based techniques that provide dynamic user interface and interaction for decision making, the method comprising:
creating a storage for a universe of data relevant for a predetermined problem in a database;
collecting data related to the predetermined problem wherein the data includes standardized information and the collected data is stored in the database;
establishing a set of a criteria to measure errors, predetermined standards and usability to measure the collected data for a predetermined problem;
a first computer processor process employing a non-transitory computer readable medium running an algorithm of cleaning techniques to:
analyzing the collected data stored in the database to detect any errors created by entering the collected data, determining if the collected data is scaled to the standard for the predetermined problem and determining if the collected data is useable for the predetermined problem;
sorting a clean data set from the collected data that was detected to have been entered in error, determined to not be scaled to the standard and determined to be not useable based on the criteria to measure the predetermined problem.
a second computer processor process having a plurality of cores and employing a non-transitory computer readable medium running a program to generate and structure a hierarchy of artificial intelligence processes comprising:
a plurality of artificial intelligence procedures operating at the same time within the cores of a processor built to solve a specified issue related to the predetermined problem wherein each core operates independently from the other cores of the processor;
a plurality of Long-Short Term Memory (LSTM) techniques that operate as artificial intelligence procedures which operate to discover relationships between the clean data in resolving the problem;
a Markov Chain Monte Carlo application running in conjunction with the long-short term memory techniques to understand network architecture and operate the LSTM techniques in parallel processes within each of the cores of the processor;
a linkage system in the Markov Chain Monte Carlo application which reviews the efficiency of the LSTM optimization processes and revises the LSTM techniques in a manner to increase the efficiency of the LSTM techniques operating in parallel processes within the cores of the processor; and
resolving a solution to the predetermined problem from an analysis of the clean data to generate an ensemble of a collected data.

2. A computer-implemented method for generating the structure of an ensemble system using artificial intelligence-based techniques that provide a dynamic user interface and interaction for decision making of claim 1, wherein the Markov Chain Monte Carlo application further operates to improve the clustering performance of the LSTM techniques that operate using the clean data.

3. A computer-implemented method for generating the structure of an ensemble system using artificial intelligence-based techniques that provide a dynamic user interface and interaction for decision making of claim 1, wherein the Markov Chain Monte Carlo application operates to measure a compatibility and a modularity in design of the LSTM techniques to permit rapid development and integration into a new machine learning system.

4. A computer-implemented method for generating the structure of an ensemble system using artificial intelligence-based techniques that provide a dynamic user interface and interaction for decision making of claim 2, wherein the Markov Chain Monte Carlo application operates to measure a compatibility and a modularity in design of the LSTM techniques to permit rapid development and integration into a new machine learning system.

5. A computer-implemented method for generating the structure of an ensemble system using artificial intelligence-based techniques that provide a dynamic user interface and interaction for decision making of claim 1, further comprising a server structured to generate a relational table environment and parse the collected data in a manner to populate the relational table environment with the collected data.

6. A computer-implemented method for generating the structure of an ensemble system using artificial intelligence-based techniques that provide a dynamic user interface and interaction for decision making of claim 1, further comprising a top-level artificial intelligence procedure chosen by the Markov Chain Monte Carlo application to direct and use the LSTM techniques to make decisions that direct the LSTM techniques to a solution to the predetermined problem.

7. A computer-implemented method for generating the structure of an ensemble system using artificial intelligence-based techniques that provide a dynamic user interface and interaction for decision making of claim 1, further comprising a random forest process run as a random forest top-level process.

8. A computer-implemented method for generating the structure of an ensemble system using artificial intelligence-based techniques that provide a dynamic user interface and interaction for decision making of claim 6, further comprising a random forest top-level process run as the top-level process.

9. A computer-implemented method for generating the structure of an ensemble system using artificial intelligence-based techniques that provide a dynamic user interface and interaction for decision making, comprising the steps of:
generating a random forest model top-level artificial intelligence routine;
creating a sub-level routine using an LSTM sub-process to build an asset relationship map;
wherein the forest model top-level artificial intelligence utilizes a plurality of LSTM sub-processes to build a relationship map between individual assets and form a random forest trees;
utilizing the random forest trees to select an appropriate asset for a portfolio;
repeating the random forest tree selection process to generate secondary trees wherein all assets that are selected and the selection frequently occurrence is condensed and passed onto a processor for analysis;
generating a list of original assets containing data relevant to the decision making;
using a second random forest divisions to select a practical asset prior the list of original assets using long short-term memory (LSTM) to analyze features and perform a time-varying relation detection among LSTM utilizing random forest algorithms;
adding the practical asset chosen from the analysis process to the portfolio;
eliminating an undesirable asset from the list of original assets that has a fundamental relationship with the original asset, as determined by the LSTM process to generate a first trimmed list;
continuing the process starting from the first tree, finding a second practical asset from the first trimmed list;
using a third random forest division to select a second practical asset from the list of original assets using long short-term memory to extract and analyze features and perform a time-varying relation detection among LSTM utilizing random forest algorithms;
adding the second practical asset chosen from the analysis process to the portfolio;
eliminating an undesirable asset from the list of original assets that has a fundamental relationship with the original assets, as determined by the LSTM process to generate a second trimmed list; and
trimming the portfolio based on the second trimmed asset.

10. A computer-implemented method for generating the structure of an ensemble system using artificial intelligence-based techniques that provide a dynamic user interface and interaction for decision making of claim 9, further comprising the step of considering a decision tree top-level process with a regression sub-process, a nested LSTM sub-process and a second nested simple decision tree sub-process for the purpose of suggesting a solution to a problem.

11. A computer-implemented method for generating the structure of an ensemble system using artificial intelligence-based techniques that provide a dynamic user interface and interaction for decision making of claim 9, further comprising the step of displaying an output to a user showing the suggested solution, the move, the routine is currently investigating, the second-best solution move, and the number of routines that have been searched, and the number of processors being used.

12. A computer-implemented method for generating the structure of an ensemble system using artificial intelligence-based techniques that provide a dynamic user interface and interaction for decision making of claim 11, furthering comprising the step of generating a parallel system of sub-level routines and dynamically redeploying resources wherein a plurality of artificial intelligence procedures operating at the same time within the cores of a processor wherein a first processor is assigned to process the decision making, a second processor is assigned a regression process and a third processor is assigned a neutral network process.

13. A computer-implemented method for generating the structure of an ensemble system using artificial intelligence-based techniques that provide a dynamic user interface and interaction for decision making of claim 12, wherein the top-level processor dynamically moves the sub-level routines to the processor to most efficiently generate further gains.

14. A computer-implemented method for generating the structure of an ensemble system using artificial intelligence-based techniques that provide a dynamic user interface and interaction for decision making comprising the steps of:
determining the relevant universe for the problem at hand;
collecting the appropriate data related to the universe for a given problem and store the data in a defined format within the database;
using data cleaning techniques to examine the data to determine possible errors in the data, standardize the data and improve the usability of the data analytics processes;
generating a structure for a hierarchy of artificial intelligence processes, with a top-level process structured at the highest level of the hierarchy;
developing and deploying an artificial intelligence sub-process to be used by the top-level process in an ensemble and developing sub-processes in a nested n-stage decision process, where n is the number of nested sub-processes to construct a high-dimensional model.
utilizing a Markov Chain Monte Carlo (MCMC) algorithm to search across the high-dimensional model to look for trends and patterns across the data being analyzed in the ensemble;
implementing stochastic attention to the process to customize the process with a specified structure in the ensemble;
analyzing the ensemble to explore relationships between data to create an interactive visual map of data relationships across the high-dimensional models; and
displaying the interactive visual map to the end-user.

15. A computer-implemented method for generating the structure of an ensemble system using artificial intelligence-based techniques that provide a dynamic user interface and interaction for decision making of claim 14 further comprising the steps of:
using the interactive visual map to elicit goals and objectives from an end-user; and
analyzing the goals and objectives to present the end-user with the analysis in an interactive format showing the current analysis and the state of the search.

16. A computer-implemented method for generating the structure of an ensemble system using artificial intelligence-based techniques that provide a dynamic user interface and interaction for decision making of claim 15 further comprising the step of generating an interactive display for the user to interact with various visual components that allow for additional searches and refinements in the business process wherein the user may use data and analytics from previous searches to improve the efficiency and design in newly queried search processes.

17. A computer-implemented method for generating the structure of an ensemble system using artificial intelligence-based techniques that provide a dynamic user interface and interaction for decision making of claim 14 wherein the MCMC algorithm shares information and resources across the ensemble to improved computing and performance and the MCMC algorithm operates to redirect processor functions to optimize the sub-process routines.

18. A computer-implemented method for generating the structure of an ensemble system using artificial intelligence-based techniques that provide a dynamic user interface and interaction for decision making of claim 14 wherein the MCMC algorithm operates to ensure that the top-level process is compatible with the sub-process to generate the ensemble.

19. A computer-implemented method for generating the structure of an ensemble system using artificial intelligence-based techniques that provide a dynamic user interface and interaction for decision making of claim 18, wherein the MCMC algorithm characterizes statistical distributions and or mathematical topologies that are too mathematically complex to easily describe or solve using traditional techniques.

20. A computer-implemented method for generating the structure of an ensemble system using artificial intelligence-based techniques that provide a dynamic user interface and interaction for decision making of claim 19, wherein the MCMC algorithm is modular in nature and is designed to be packaged and run in feedback and conjunction with the ensemble distributing information across an ensemble stack.
